(19) United States
(12) Patent Application Publication
(10) Pub. No.: US 2016/0311267 A1
(43) Pub. Date: Oct. 27, 2016

(54) Pneumatic Tire

(71) Applicant: THE YOKOHAMA RUBBER CO., LTD., Minato-ku, Tokyo (JP)

(72) Inventor: Kenichi Matsumoto, Hiratsuka-shi, Kanagawa (JP)

(73) Assignee: The Yokohama Rubber Co., LTD., Minato-ku, Tokyo (JP)

(21) Appl. No.: 15/103,289

(22) PCT Filed: Dec. 9, 2014
(86) PCT No.: PCT/JP2014/082480

§ 371 Date: Jun. 9, 2016

(30) Foreign Application Priority Data
Dec. 9, 2013 (JP) 2013-253846

(51) Int. Cl. B60C 11/16

(52) U.S. Cl. CPC B60C 11/1637; B60C 11/1656; B60C 11/1643; B60C 11/1675; B60C 11/1625

(57) ABSTRACT

Provided is a pneumatic tire which includes a tire tread section provided with a plurality of stud pin inserting holes in a tread surface and a plurality of stud pins inserted into the holes. The holes each include a securing portion coming into contact with an entire periphery of each of the stud pins to secure the stud pin. The securing portion includes a protrusion provided on an inner wall thereof, the protrusion extending in a depth direction of the holes and guiding claws of a pin driver in the depth direction of the holes, the pin driver driving the stud pins into the holes. The protrusion deforms to match an outer peripheral surface of the stud pin inserted into each of the holes, such that an entire surface of the protrusion comes into contact with the outer peripheral surface of the stud pin.

### TECHNICAL FIELD

The present technology relates to pneumatic tires with stud pins fitted into tread sections.

### BACKGROUND ART

Conventional snow tires provide grip on icy road surfaces via stud pins fitted into the tread sections of the tires.

Typical stud pins are inserted into stud pin installation holes provided in the tread section. A stud gun is used to expand the diameter of the stud pin installation hole and then to insert the stud pin into the stud pin installation hole. This operation firmly inserts the stud pin into the stud pin installation hole and thus prevents the stud pin from dropping from the stud pin installation hole upon receiving force in breaking or accelerating or lateral force from the road surface during rolling motion of the tire.

A spike (stud pin) for a tire that can achieve enhanced clawing force against a surface of ice and weight reduction is known as a stud pin (International Patent Publication No. WO/2012/117962). The stud pin is provided with a columnar body to be secured to the tread surface of the tire by being fitted into a bottomed hole formed in the tread surface with one end side of the columnar body in the direction along its central axis facing the bottom of the hole; and a pin protruding from the other end face of the columnar body in the direction along its central axis.

However, snow tires with stud pins travel not only on icy road surfaces, but also on concrete road surfaces and asphalt road surfaces. Since concrete road surfaces and asphalt road surfaces are harder than icy road surfaces, the force applied by the surfaces to the tires in braking, accelerating, or cornering may often cause drop of the stud pins (hereinafter referred to as pin drop). The pin drop thus needs to be prevented in the pneumatic studded tires.

A stud pin installation hole with a small diameter holds a stud pin with improved force and thus prevents drop of the stud pin. Unfortunately, a stud pin installation hole with a small diameter requires great force to expand the diameter of the stud pin installation hole with a stud gun, and thus decreases the efficiency of stud pin installing work and increases the working time.

### SUMMARY

The present technology provides a pneumatic tire from which stud pins are difficult to drop and into which the stud pins are readily installed.

According to an aspect of the present technology, a pneumatic tire includes a tire tread section provided with a plurality of stud pin inserting holes in a tread surface and a plurality of stud pins inserted into the holes. The holes each include a securing portion coming into contact with an entire periphery of each of the stud pins to secure the stud pin. The securing portion includes a protrusion provided on an inner wall thereof, the protrusion extending in a depth direction of the holes and guiding claws of a pin driver in the depth direction of the holes, the pin driver driving the stud pins into the holes. The protrusion deforms to match an outer peripheral surface of the stud pin inserted into each of the holes, such that an entire surface of the protrusion comes into contact with the outer peripheral surface of the stud pin.

According to another aspect of the present technology, a pneumatic tire includes a tire tread section provided with a plurality of stud pin inserting holes in a tread surface and a plurality of stud pins inserted into the holes. The holes each include a securing portion coming into contact with an entire periphery of each of the stud pins to secure the stud pin. The securing portion includes a plurality of protrusions provided on an inner wall thereof, the protrusions extending in a depth direction of the holes with spacing between the protrusions in a circumferential direction of the holes, the protrusions guiding claws of a pin driver in the depth direction of the holes, the pin driver driving the stud pins into the holes. The protrusions deform to match an outer peripheral surface of the stud pin inserted into each of the holes, such that entire surfaces of the protrusions come into contact with the outer peripheral surface of the stud pin.

Preferably, the number of the protrusions is two to four.

Preferably, when D represents a diameter of a cylinder circumscribing the securing portion, and H represents a protruding height of the protrusion from a protruding base to a protruding tip, a relationship of 0.10≦H/D≦0.30 is satisfied.

Preferably, when D represents a diameter of a cylinder circumscribing the securing portion, and W represents a distance between protruding bases of the protrusion in a circumferential direction of the holes, a relationship of 0.15≦W/D≦0.45 is satisfied.

Preferably, when L represents a length of the securing portion in the depth direction of the holes, and L1 represents a length of the protrusion in the depth direction of the holes, a relationship of 0.125≦L1/L≦1.00 is satisfied.

According to yet another aspect of the present technology, a pneumatic tire includes a tire tread section provided with a plurality of stud pin inserting holes in a tread surface of the pneumatic tire and a plurality of stud pins inserted into the holes. The stud pins each include a recessed portion provided on an outer periphery thereof, the recessed portion extending in a depth direction of the hole. The holes each include a securing portion provided on an inner wall thereof, the securing portion coming into contact with an entire periphery of each of the stud pins to secure the stud pin. The securing portion includes a protrusion extending in the depth direction of the holes and guiding claws of a pin driver in the depth direction of the holes, the pin driver driving the stud pins into the holes, the protrusion engaging with the recessed portion. The protrusion deforms to match an outer peripheral surface of the stud pin inserted into each of the holes, such that an entire surface of the protrusion comes into contact with the outer peripheral surface of the stud pin.

According to yet another aspect of the present technology, a pneumatic tire includes a tire tread section provided with a plurality of stud pin inserting holes in a tread surface of the pneumatic tire and a plurality of stud pins inserted into the holes. The stud pins each include a polygonally prismatic body portion. The holes each include a securing portion provided on an inner wall thereof, the securing portion coming into contact with an entire periphery of the body portion to secure each of the stud pins. The securing portion includes a plurality of protrusions extending in the depth direction of the holes with spacing between the protrusions in a circumferential direction of the holes, the protrusions guiding claws of a pin driver in the depth direction of the holes, the pin driver driving the stud pins into the holes. The protrusions deform to match an outer peripheral surface of the body portion, such that entire surfaces of the protrusions come into contact with the outer peripheral surface of the body portion.

According to the above aspects, the present technology provides a pneumatic tire from which stud pins are more difficult to drop and into which the stud pins are more readily installed than conventional ones.

### BRIEF DESCRIPTION OF DRAWINGS

FIG. 1 is a planar development diagram illustrating a portion of a tread pattern of the tire of an embodiment developed on a plane.

FIG. 2 is a plan view of a stud pin inserting hole 20A according to a first embodiment of the present technology, viewed from a tread section.

FIG. 3 is a cross-sectional view taken along the line of FIG. 2.

FIG. 4 is a perspective view of a stud pin 50A.

FIG. 5 is a schematic view of a stud gun.

FIG. 6 illustrates how to install the stud pin in the hole with the stud gun.

FIG. 7 is a cross-sectional view taken along the line VII-VII of FIG. 6.

FIG. 8 illustrates how to install the stud pin in the hole with the stud gun.

FIG. 9 is a cross-sectional view taken along the line IX-IX of FIG. 8.

FIG. 10 illustrates how to install the stud pin in the hole with the stud gun.

FIG. 11 is a cross-sectional view taken along the line XI-XI of FIG. 10.

FIG. 12 is a perspective view of a stud pin 50B.

FIG. 13 is a plan view of a hole 20B according to a modified example of the present technology, viewed from the tread section.

FIG. 14 is a plan view of a hole 20C according to a modified example of the present technology, viewed from the tread section.

### DETAILED DESCRIPTION

A pneumatic tire according to an embodiment of the present technology will now be described.

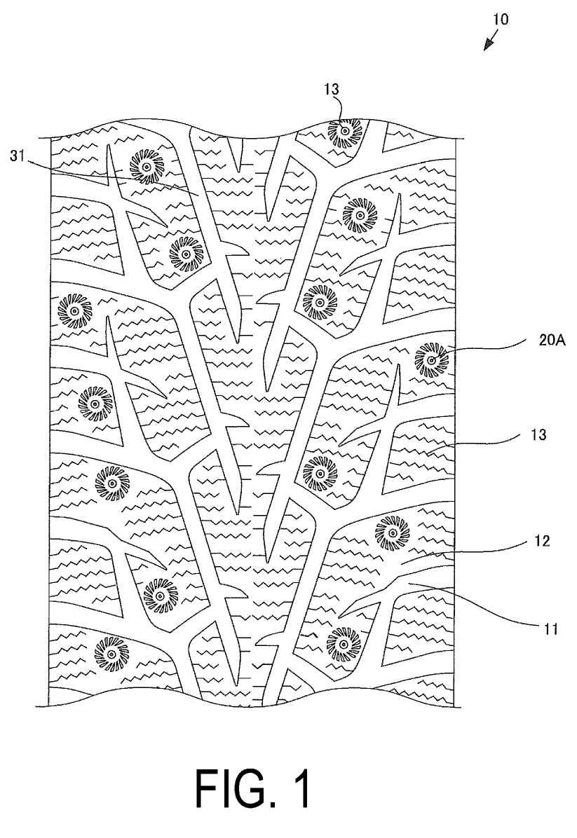

FIG. 1 is a planar development diagram illustrating a portion of a tread pattern, developed on a plane, of a tread section 10 of the pneumatic tire (hereinafter referred to as tire) in this embodiment.

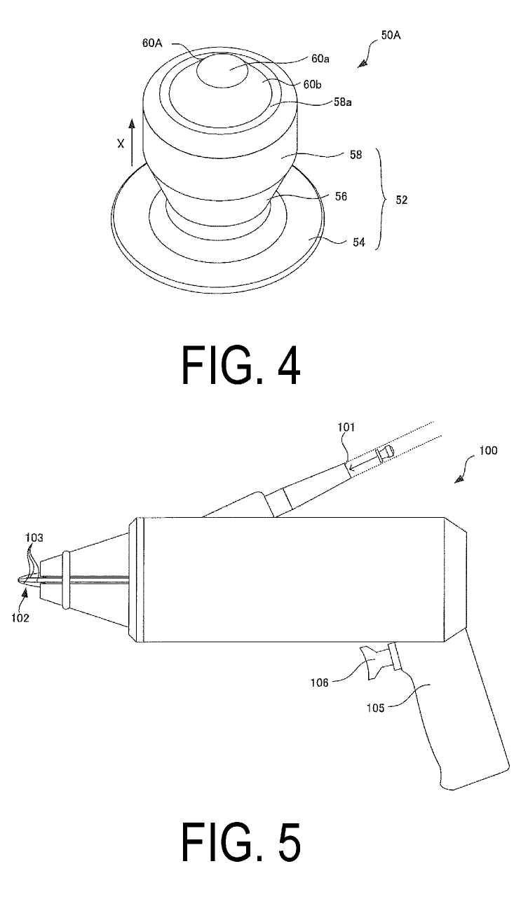

Grooves 11 are formed in the tread section 10. The grooves 11 define a plurality of land parts 12. Sipes 13 are disposed in the surfaces (road contact surfaces) of the land parts 12. Holes 20A into which stud pins 50A (See FIG. 4) are fitted are disposed in the surfaces of the land parts 12. Fitting the stud pins 50A into the holes 20A allows the tire 10 to function as a studded tire, resulting in an improvement in performance on ice, such as braking and turning on ice.

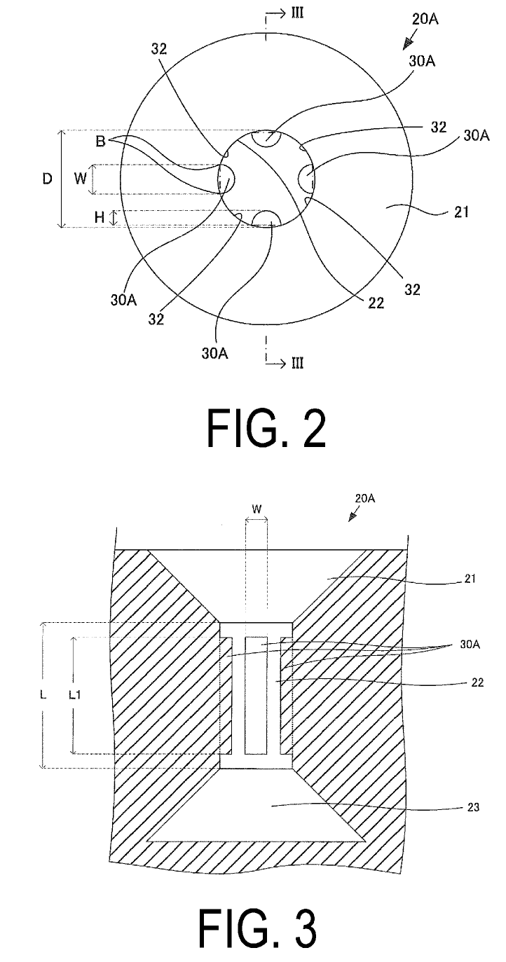

FIG. 2 is a plan view of the hole 20A. FIG. 3 is a cross-sectional view taken along the line of FIG. 2. The hole 20A includes an entrance portion 21, a securing portion 22, and an enlarged diameter portion 23 that are formed in this order from the surface of the land part 12 in the depth direction.

The cross-sectional area of the opening of the entrance portion 21 decreases from the surface of the land part 12 in the depth direction to approximately one fifth of the cross-sectional area at the surface of the land part 12.

The securing portion 22 is provided extending in the depth direction from the deepest end of the entrance portion 21. The securing portion 22 is substantially cylindrical and has one or more protrusions 30A provided on the inner wall surface thereof as illustrated in FIGS. 2 and 3. The protrusions 30A deform to match the outer peripheral surfaces of a body portion 58 and a shank portion 56 of the stud pin 50A inserted into the securing portion 22, such that the entire surfaces of the protrusions come into contact with the outer peripheral surfaces of the body portion 58 and the shank portion 56. This configuration allows the protrusions 30A to press the outer peripheral surfaces of the body portion 58 and the shank portion 56 and to compress and secure the stud pin.

With reference to FIG. 2, if the securing portion 22 is cylindrical, the diameter D of the securing portion and the protruding height H of the protrusion 30A from the protruding base B to the protruding tip T preferably have a relationship of 0.10≦H/D≦0.30. If the securing portion 22 is not cylindrical, the diameter D of the cylinder C circumscribing the inner wall surface of the securing portion 22 and the protruding height H of the protrusion 30A from the protruding base B to the protruding tip T preferably have a relationship of 0.10≦H/D≦0.30. A ratio of H/D of less than 0.10 provides insufficient compressing force against the body portion 58 and the shank portion 56 of the stud pin 50A. A ratio of H/D of greater than 0.30 provides sufficient compressing force against the body portion 58 and the shank portion 56 of the stud pin 50A but requires stronger force in expanding the securing portion 22 to insert a flange 54 of the stud pin 50A, resulting in a decrease in workability.

Each of the protrusions 30A extends in the depth direction as illustrated in FIG. 3. With reference to FIG. 2, the length L of the securing portion 22 in the depth direction and the length L1 of the protrusion 30A in the depth direction of the hole 20A preferably have a relationship of 0.125≦L1/L≦1.00. A ratio of L1/L of less than 0.125 provides insufficient compressing force against the body portion 58 and the shank portion 56 of the stud pin 50A. The ratio of L1/L cannot be greater than 1.

When W represents the distance between the protruding bases B and B in the circumferential direction along the inner wall surface of the securing portion 22 as illustrated in FIG. 2, the relationship of 0.15≦W/D≦0.45 is preferably satisfied.

A ratio of W/D of less than 0.15 provides insufficient compressing force against the body portion 58 and the shank portion 56 of the stud pin 50A. A ratio of W/D of greater than 0.45 provides sufficient compressing force against the body portion 58 and the shank portion 56 of the stud pin 50A but requires stronger force in expanding the securing portion 22 to insert the flange 54 of the stud pin 50A, resulting in a decrease in workability.

If a plurality of protrusions 30A is provided, the protrusions 30A are preferably disposed with spacing therebetween in the circumferential direction of the inner wall surface of the securing portion 22 as illustrated in FIG. 2. The protrusions 30A are preferably disposed at regular intervals in the circumferential direction. Claws of a stud gun enter recesses 32 between the protrusions 30A on the inner wall of the securing portion 22 and are guided by the protrusions 30A in the depth direction of the hole 20A, which will be described later. Thus, the number of the recesses 32, i.e., the number of the protrusions 30A is preferably the same as the number of claws of a typical stud guns. Since typical stud guns have two to four claws, the number of the protrusions 30A is preferably two to four.

The enlarged diameter portion 23 is provided extending in the depth direction from the deepest end of the securing portion 22. The cross-sectional area of the opening of the enlarged diameter portion 23 increases approximately four times from the deepest end of the securing portion 22 in the depth direction. The flange 54, which will be described later, of the stud pin 50A is disposed in the enlarged diameter portion 23. The enlarged diameter portion 23 presses the entire surface of the flange 54 of the stud pin 50A and compresses and secures the stud pin 50A.

Stud Pin

FIG. 4 is an external perspective view illustrating the stud pin 50A according to the first embodiment of the present technology. The stud pin 50A mainly includes a buried base portion 52 and a tip portion 60A that are formed in this order in the X direction.

The buried base portion 52 is pressed by the inner wall surface of the enlarged diameter portion 23 of the hole 20A. This configuration secures the stud pin 50A in the tread section.

The stud pin 50A includes the buried base portion 52 and the tip portion 60A. When the stud pin 50A is fitted into the hole 20A, the X direction coincides with the normal direction to the surface of the land part 12.

The buried base portion 52 includes the flange 54, the shank portion 56, and the body portion 58 that are formed in this order in the X direction.

The flange 54 is located at an end opposite the tip portion 60A. The flange 54 has a disk shape and prevents rotation of the stud pin 50A in a stud pin installation hole 45 when the stud pin 50A receives force from the road surface. The shank portion 56 connects the body portion 58 to the flange 54. The shank portion 56 has a truncated cone shape with a diameter less than the maximum outer diameter of the flange 54 and that of the body portion 58. The shank portion 56 is formed as a recessed portion relative to the body portion 58 and the flange 54, and the flange 54 and the body portion 58 are formed like flanges.

The body portion 58 is cylindrical, is located between the shank portion 56 and the tip portion 60A, and is connected to the tip portion 60A. The body portion 58 is embedded in a tread rubber material 18, with an upper end surface 58a of the body portion 58 being exposed, flush with the tread surface when the stud pin 50A is fitted into the tire 10.

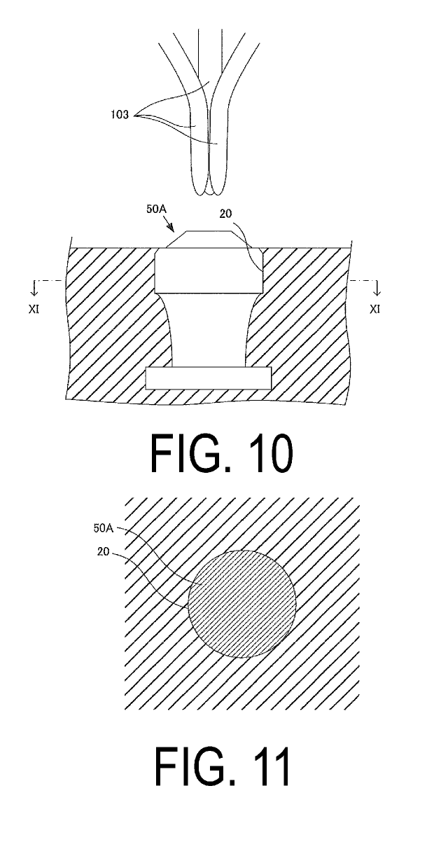

The tip portion 60A protrudes from the tread surface when the stud pin 50A is fitted in the tread section as illustrated in FIG. 10, and comes into contact with the road surface or claws into the ice. The tip portion 60A is the truncated cone portion protruding from the upper end surface 58a of the buried base portion 52. The tip of the tip portion 60A (the end in the X direction) is formed into a flat surface 60a perpendicular to the extending direction of the buried base portion 52 (X direction). The tip portion 60A includes an inclined side surface 60b extending from the outer periphery of the flat surface 60a to the upper end surface 58a of the buried base portion 52. The inclined side surface 60b has an acute angle of inclination θ with respect to the upper end surface 58a of the body portion 58. The angle of inclination is preferably from 30 to 60 degrees.

The tip portion 60A may be made from the same metal material as that of the buried base portion 52 or of different metal material. For example, the buried base portion 52 and the tip portion 60A may be made from aluminum. Also, the buried base portion 52 may be made from aluminum and the tip portion 60A may be made from tungsten carbide. In the case that the buried base portion 52 and the tip portion 60A are made from different metal materials, the tip portion 60A can be anchored to the buried base portion 52 by mating a protruding portion (not illustrated) provided on the tip portion 60A with a hole (not illustrated) formed in the upper end surface 58a of the body portion 58 of the buried base portion 52.

FIG. 5 is a side view of a stud gun 100 used for installing the stud pins in the holes (stud pin inserting holes) 20A provided in the tread section 10 of the tire in this embodiment. The stud gun 100 includes a supply port 101 supplying the stud pins, a discharge port 102 discharging the stud pins, a plurality of claws 103 closing the discharge port 102, and an operating unit 104 allowing an operator to control opening and closing of the claws 103, as illustrated in FIG. 5.

The stud pin is supplied from an external stud pin storage (not illustrated) to the supply port 101 with high-pressure air. The stud pin supplied from the supply port 101 is discharged from the discharge port 102.

The discharge port 102 is normally closed by the claws 103 to prevent the stud pin supplied from the supply port 101 from being discharged and is opened by opening the claws 103. The stud pin urged by the high-pressure air is discharged from the opened discharge port 102.

The operating unit 104 includes a grip 105 for the operator to hold the stud gun and a lever 106 disposed on the grip 105. When the operator holds the grip 105 and pulls the lever 106, the claws 103 are opened to discharge the stud pin urged by the high-pressure air from the discharge port 102.

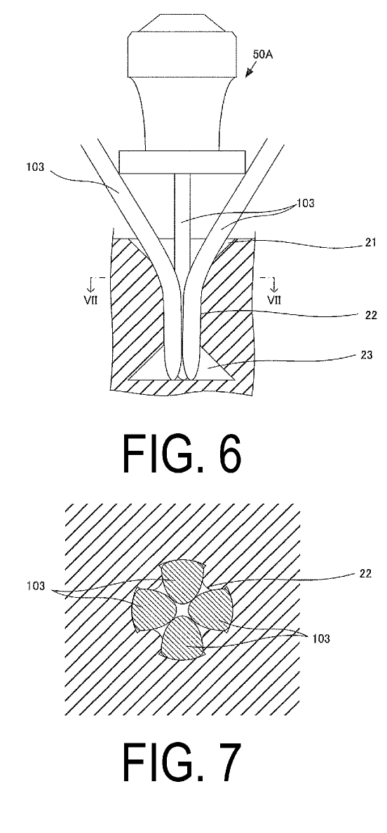

A method of installing the stud pin 50A into the hole 20A with the stud gun 100 will now be described with reference to FIGS. 6 to 10.

FIG. 6 is a cross-sectional view of the hole 20A. FIG. 7 is a cross-sectional view taken along the line VII-VII of FIG. 6. First, the closed claws 103 of the stud gun 100 are inserted into the hole 20A as illustrated in FIGS. 6 and 7. The claws 103 of the stud gun 100 enter the recesses 32 between the protrusions 30A disposed on the securing portion 22 of the hole 20A and are guided by the protrusions 30A in the depth direction of the hole 20A. This operation facilitates the insertion of the claws 103 into the hole 20A.

The closed claws 103 stop the stud pin 50A to prevent the stud pin 50A from being discharged from the discharge port 102 as illustrated in FIG. 6.

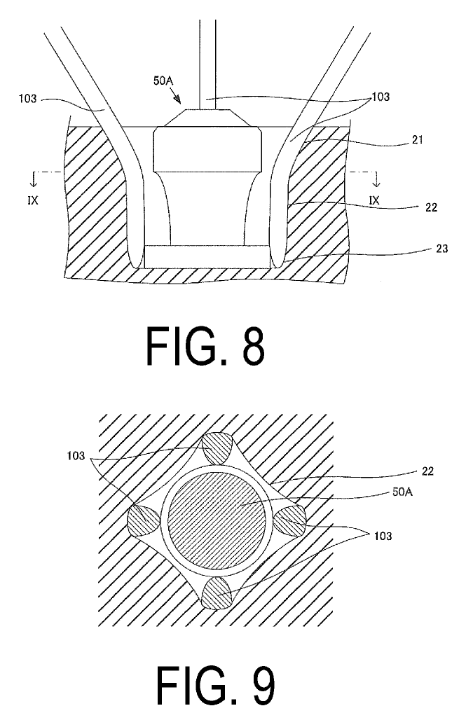

Second, the operator holds the grip 105 and pulls the lever 106 to open the claws 103 as illustrated in FIGS. 8 and 9. This operation inserts the stud pin 50A into the hole 20A with its diameter enlarged by the claws 103.

Third, the operator pulls out the claws 103 from the hole 20A, and the stud pin 50A remains in the hole 20A as illustrated in FIGS. 10 and 11. The inner wall surface of the hole 20A presses the outer peripheral surface of the stud pin 50A to compress and secure the stud pin 50A in the tread section 10. The outer diameter of the stud pin 50A is larger than the inner diameter of the hole 20A. This configuration allows the inner wall surface of the hole 20A to closely contact the outer peripheral surface of the stud pin 50A and provides no gap between the inner wall surface of the hole 20A and the outer peripheral surface of the stud pin 50A.

According to this embodiment of the present technology, the protrusions 30A protruding radially inward of the hole 20A and extending in the depth direction of the hole 20A are disposed on the inner wall of the securing portion 22 of the hole 20A, and the claws 103 of the stud gun 100 enter the recesses 32 between the protrusions 30A and are guided by the protrusions 30A in the depth direction of the hole 20A. This configuration facilitates the insertion of the claws 103 into the hole 20A. The protrusions 30A protruding inward of the hole 20A press the outer peripheral surfaces of the body portion 58 and the shank portion 56 of the stud pin 50A inserted into the securing portion 22 and compress and secure the stud pin 50A, and thus prevent drop of the stud pin 50A. The hole 20A can thus hold the stud pin 50A with improved force without a decrease in the efficiency of installing the stud pin 50A.

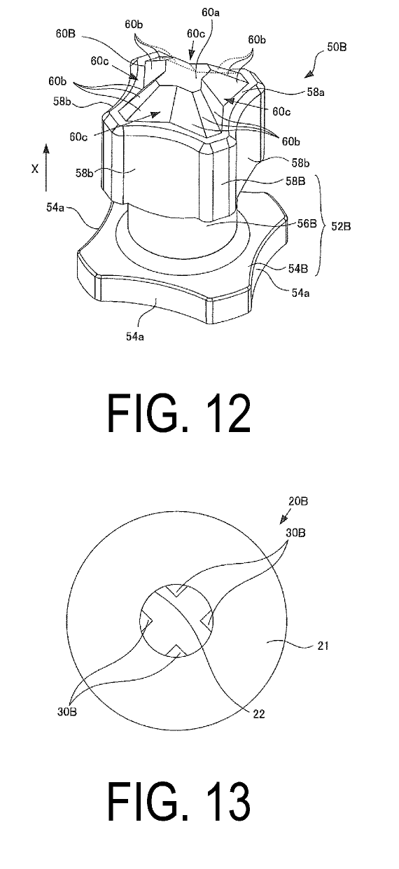

FIG. 12 is a perspective view of a stud pin 50B according to another embodiment of the present technology. The stud pin 50B includes a buried base portion 52B and a tip portion 60B that are shaped differently from those in the above embodiment.

The buried base portion 52B includes a flange 54B, a shank portion 56B, and a body portion 58B that are formed in this order in the X direction as illustrated in FIG. 12.

A recessed portion 54a is formed in the outer peripheral surface of the flange 54B that comes into contact with the side surface of the stud pin installation hole 45. Specifically, the cross section of the flange 54B is substantially quadrangular with rounded corners. The four sides of the substantially quadrangular shape are recessed to form four of the recessed portions 54a. The cross section of the flange 54B may not be substantially quadrangular with rounded corners and may be substantially triangular, pentagonal, or hexagonal, or may have any substantially polygonal shape. The substantially polygonal flange 54B prevents or minimizes rotational motion of the stud pin 50B about its central axis aligned with the X direction. Note that the rounded corners of the flange 54 can prevent damage to the side surface of the stud pin installation hole 45. In this case, the recessed portion 54a is preferably formed by at least one side of the substantially polygonal shape being recessed. Of course, a plurality of recessed portions 54a may be formed by a portion of or all of the sides of the substantially polygonal shape, for example two sides, three sides, four sides, five sides, six sides, or the like, being recessed. Forming the recessed portion 54a can increase the surface area per unit volume of the flange 54B and can thus increase the surface contact area with the tread rubber material 18 of the tread section and the friction force restricting movement of the stud pin 50B. The tread rubber material 18 filling the recessed portion 54a also prevents or minimizes rotational motion of the stud pin 50B about its central axis aligned with the X direction.

The shank portion 56B connects the body portion 58B to the flange 54B. The shank portion 56B has a cylindrical shape with a diameter less than the maximum outer diameter of the flange 54B and that of the body portion 58B. The shank portion 56 is formed as a recessed portion relative to the body portion 58 and the flange 54B, and the flange 54B and the body portion 58B are formed like flanges. Recessed portions are not formed in the outer peripheral surface of the shank portion 56B.

The body portion 58B is located between the shank portion 56B and the tip portion 60B and is the flange-like portion connected to the tip portion 60B. A recessed portion 58b is formed on the outer peripheral surface, pressed by the side surface of the stud pin installation hole, of the body portion 58B. This outer peripheral surface is brought into contact with and pressed by the tread rubber material 18 of the tread section, and the friction force thus generated restricts movement of the stud pin 50B.

Explaining the body portion 58B in detail, the body portion 58 has a cross section perpendicular to the X direction that is substantially quadrangular having rounded corners with four of the recessed portions 58b formed by the four sides being recessed. In the present embodiment, four of the recessed portions 58b are provided on the outer peripheral surface. However, at least one recessed portion 58b, such as one, two, or three recessed portions, may be provided. The cross section of the body portion 58B may not be substantially quadrangular with rounded corners and may be substantially triangular, pentagonal, or hexagonal, or may have any substantially polygonal shape.

The substantially polygonal body portion 58B prevents or minimizes rotational motion of the stud pin 50B about its central axis aligned with the X direction. The number of the recessed portions 58b is preferably the same as the number of the protrusions 30A disposed on the securing portion 22. Preferably, the circumferential spacing between the recessed portions 58b disposed in the body portion 58B is substantially the same as the circumferential spacing between the protrusions 30A disposed on the securing portion 22. This configuration allows the recessed portions 58b of the body portion 58B to engage with the protrusions 30A of the securing portion 22 and thus further prevents or minimizes rotational motion of the stud pin 50B about its central axis aligned with the X direction.

Note that the rounded corners of the body portion 58B of the stud pin 50B achieved by rounding the corners of the substantially polygonal shape can prevent damage to the side surface of the stud pin installation hole.

In this case, the recessed portion 58b is preferably formed by at least one side of the substantially polygonal shape being recessed. Of course, a plurality of recessed portions 58b may be formed by a portion of or all of the sides of the substantially polygonal shape, for example two sides, three sides, four sides, five sides, six sides, or the like, being recessed. Forming the recessed portion 58b can increase the surface area per unit volume of the body portion 58B and can thus increase the surface contact area with the tread rubber material 18 of the tread section and the friction force restricting movement of the stud pin 50B. The tread rubber material 18 filling the recessed portion 58b also prevents or minimizes rotational motion of the stud pin 50B about its central axis aligned with the X direction.

The body portion 58B is embedded in the tread rubber material 18, with the upper end surface 58a being exposed, flush with the tread surface when the stud pin 50B is fitted into the tire 10.

With reference to FIG. 12, the tip of the tip portion 60B (the end in the X direction) is formed into a flat surface 60a perpendicular to the extending direction of the buried base portion 52 (X direction). The flat tip surface 60a of the tip portion 60B is shaped into a concave polygon having at least one interior angle of greater than 180 degrees. As concave polygons have a greater sum of the lengths of the sides than circles or convex polygons with the same area, the flat tip surface 60a shaped into a concave polygon can increase the number of edges of the tip portion 60B that claw into the road surface and can thus enhance the clawing force that the stud pin 50B receives from the road surface. For example, the flat tip surface 60a can be cross shaped or star shaped.

The cross section of the tip portion 60B in the direction orthogonal to the X direction may have a different shape from the flat tip surface 60a; however, a similar shape to the flat tip surface 60a is preferable.

Twelve inclined side surfaces 60b extend at an inclination from the sides of the flat surface 60a to the upper end surface 58a of the body portion 58. A recessed portion 60c is defined by at least one pair of the inclined side surfaces 60b extending from the sides of the flat surface 60a that form an interior angle greater than 180 degrees. Forming the recessed portion 60c can increase the number of edges of the tip portion 60B that claw into the road surface and can thus enhance the clawing force that the stud pin 50B receives from the road surface.

The stud pin 50B in this embodiment can also be fitted into the same hole 20A in the tread section 10 as that in the first embodiment by the same method for the stud pin 50A according to the first embodiment. The outer diameter of the stud pin 50A is larger than the inner diameter of the hole 20A. This configuration allows the inner wall surface of the hole 20A to closely contact the outer peripheral surface of the stud pin 50A and provides no gap between the inner wall surface of the hole 20A and the outer peripheral surface of the stud pin 50A.

The stud pin 50B, according to this embodiment, fitted into the hole 20A achieves the same advantageous effects as those in the first embodiment and allows the recessed portions 58b of the body portion 58B of the stud pin 50B to engage with the protrusions 30A of the securing portion 22 of the hole 20A to further prevent or minimize rotational motion of the stud pin 50B about its central axis aligned with the X direction. Rotational motion of the stud pin 50B about its central axis aligned with the X direction is prevented or minimized in this way, and the stud pin 50B can be further prevented from dropping from the hole 20A in the tread section 10.

### FIRST MODIFIED EXAMPLE

FIG. 13 is a plan view of a hole 20B according to a first modified example of the present technology, viewed from the tread section. In this modified example, protrusions 30B have a substantially triangular-prismatic shape, which is different from the protrusion 30A in the above embodiments. Even with the protrusions 30B having such a shape, the protrusions 30A disposed on the inner wall of the securing portion 22 of the hole 20B, protruding inward of the hole 20B, and extending in the depth direction of the hole 20B allow the claws 103 of the stud gun 100 to enter between the protrusions 30B and to be guided by the protrusions 30B in the depth direction of the hole 20B. This configuration facilitates the insertion of the claws 103 into the hole 20B. The protrusions 30B protruding inward of the hole 20B deform to match the outer peripheral surface of the stud pin inserted into the securing portion 22, press the outer peripheral surface of the stud pin, compress and secure the stud pin, and thus prevent drop of the stud pin. The hole 20B can thus hold the stud pin with improved force without a decrease in the efficiency of installing the stud pin.

### SECOND MODIFIED EXAMPLE

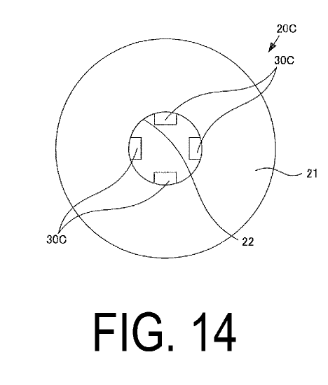

FIG. 14 is a plan view of a hole 20C according to a second modified example of the present technology, viewed from the tread section. In this modified example, protrusions 30C have a substantially quadrangular-prismatic shape, which is different from the protrusion 30A in the above embodiments. Even with the protrusions 30C having such a shape, the protrusions 30C disposed on the inner wall of the securing portion 22 of the hole 20C, protruding inward of the hole 20C, and extending in the depth direction of the hole 20C allow the claws 103 of the stud gun 100 to enter between the protrusions 30C and to be guided by the protrusions 30C in the depth direction of the hole 20C. This configuration facilitates the insertion of the claws 103 into the hole 20C. The protrusions 30C protruding inward of the hole 20C deform to match the outer peripheral surface of the stud pin inserted into the securing portion 22, press the outer peripheral surface of the stud pin, compress and secure the stud pin, and thus prevent drop of the stud pin. The hole 20C can thus hold the stud pin with improved force without a decrease in the efficiency of installing the stud pin.

### EXPERIMENT EXAMPLES

To test the effects of the tire according to the embodiments, the stud pins illustrated in FIG. 4 were fitted in the tire, provided with the stud pin installation holes in the tread section, illustrated in FIG. 1. The configurations of the holes are described in the following Comparative Examples 1 to 3 and Working Examples 1 to 16.

Tables 1 and 2 show the diameters D of the securing portions of the holes, the numbers of the protrusions disposed on the securing portions, the ratios (H/D) of the protruding heights H of the protrusions from the protruding bases to the protruding tips to D, the ratios (W/D) of the distances W between the protruding bases of the protrusions in the circumferential direction to D, and the ratios (L1/L) of the lengths L1 of the protrusions in the depth direction of the holes to the lengths L of the securing portions in the depth direction of the holes. No protrusion was provided in Comparative Examples 1 to 3.

The tires 10 were fitted to a passenger vehicle to check pin drop resistance and pin driving performance.

The size of each manufactured tire was 205/55R16. The passenger vehicle used was a front wheel drive sedan type passenger vehicle with an engine displacement of 2000 cc. The internal pressure condition of the tires was 230 (kPa) for both the front wheels and rear wheels. The load condition of the tires was a 450 kg load on the front wheels and a 300 kg load on the rear wheels.

### Pin Drop Resistance

As pin drop resistance, the proportion of the number of stud pins remaining in the tread section to the total number of fitted stud pins was obtained after the vehicle traveled 1000 km on a dry road surface including asphalt road surfaces or concrete road surfaces.

The proportion of remaining stud pins was indexed with reference to the proportion of remaining stud pins in Comparative Example 1 (index of 100). The results are shown in Tables 1 and 2.

### Pin Driving Performance

The working time taken for driving all of a fixed number of stud pins into a single tire with the same stud gun was measured. The working time was indexed with reference to the inverse of the working time in Comparative Example 1 (index of 100).

The results are shown in Tables 1 and 2.

TABLE 1

| | Working Example | | | | | | | | |
|---|---|---|---|---|---|---|---|---|---|
| | 1 | 2 | 3 | 4 | 5 | 6 | 7 | 8 | 9 |
| Number of | 1 | 1 | 1 | 1 | 1 | 1 | 1 | 1 | 1 |
| protrusions | | | | | | | | | |
| D (mm) | 2.0 | 2.0 | 2.0 | 2.0 | 2.0 | 2.0 | 2.0 | 2.0 | 2.0 |
| H/D | 0.05 | 0.10 | 0.20 | 0.30 | 0.35 | 0.20 | 0.20 | 0.20 | 0.20 |
| W/D | 0.30 | 0.30 | 0.30 | 0.30 | 0.30 | 0.10 | 0.15 | 0.45 | 0.50 |
| L1/L | 0.650 | 0.650 | 0.650 | 0.650 | 0.650 | 0.650 | 0.650 | 0.650 | 0.650 |
| Pin drop | 104 | 108 | 110 | 114 | 116 | 104 | 108 | 112 | 114 |
| resistance | | | | | | | | | |
| Pin driving | 104 | 102 | 100 | 98 | 94 | 104 | 102 | 98 | 94 |
| performance | | | | | | | | | |

TABLE 2

| | | | | | | | | Comparative | | |
|---|---|---|---|---|---|---|---|---|---|---|
| | Working Example | | | | | | | Example | | |
| | 10 | 11 | 12 | 13 | 14 | 15 | 16 | 1 | 2 | 3 |
| Number of | 1 | 1 | 1 | 2 | 3 | 4 | 5 | 0 | 0 | 0 |
| protrusions | | | | | | | | | | |
| D (mm) | 2.0 | 2.0 | 2.0 | 2.0 | 2.0 | 2.0 | 2.0 | 2.0 | 1.8 | 2.2 |
| H/D | 0.20 | 0.20 | 0.20 | 0.20 | 0.20 | 0.20 | 0.20 | 0 | 0 | 0 |
| W/D | 0.30 | 0.30 | 0.30 | 0.30 | 0.30 | 0.30 | 0.30 | 0 | 0 | 0 |
| L1/L | 0.100 | 0.125 | 1.000 | 0.650 | 0.650 | 0.650 | 0.650 | 0 | 0 | 0 |
| Pin drop | 104 | 108 | 114 | 112 | 114 | 116 | 118 | 100 | 120 | 80 |
| resistance | | | | | | | | | | |
| Pin driving | 104 | 102 | 98 | 98 | 96 | 94 | 88 | 100 | 80 | 120 |
| performance | | | | | | | | | | |

On comparison between Comparative Examples 1 to 3 in Table 1, a greater value of D decreases pin drop resistance but improves pin driving performance. On comparison between Comparative Examples 1 to 3 and Working Examples 1 to 16, it is understood that providing the protrusion(s) improves pin drop resistance while slightly decreasing or maintaining pin driving performance.

On comparison between Working Examples 1 to 5, it is understood that a ratio of H/D of 0.10 or greater significantly improves pin drop resistance in comparison with a ratio of H/D of less than 0.10. It is understood that a ratio of H/D of greater than 0.30 significantly decreases pin driving performance.

On comparison between Working Examples 3 and 6 to 9, it is understood that a ratio of W/D of 0.15 or greater significantly improves pin drop resistance in comparison with a ratio of W/D of less than 0.15. It is understood that a ratio of W/D of greater than 0.45 significantly decreases pin driving performance.

On comparison between Working Examples 3 and 10 to 12, it is understood that a ratio of L1/L of 0.125 or greater significantly improves pin drop resistance in comparison with a ratio of L1/L of less than 0.125.

On comparison between Working Examples 3 and 13 to 16, it is understood that two or more protrusions significantly improves pin drop resistance in comparison with one protrusion. It is understood that five or more protrusions significantly decreases pin driving performance.

The pneumatic tire according to the present technology described above in detail is not limited to the above embodiments and may be enhanced or modified in various ways within the scope of the present technology.

1. A pneumatic tire comprising:
a tire tread section provided with a plurality of stud pin inserting holes in a tread surface; and
a plurality of stud pins inserted into the holes;
the holes each including a securing portion coming into contact with an entire periphery of each of the stud pins to secure the stud pin;
the securing portion including a protrusion provided on an inner wall thereof, the protrusion extending in a depth direction of the holes and guiding claws of a pin driver in the depth direction of the holes, the pin driver driving the stud pins into the holes; and
the protrusion deforming to match an outer peripheral surface of the stud pin inserted into each of the holes, such that an entire surface of the protrusion comes into contact with the outer peripheral surface of the stud pin.

2. A pneumatic tire comprising:
a tire tread section provided with a plurality of stud pin inserting holes in a tread surface; and
a plurality of stud pins inserted into the holes;
the holes each including a securing portion coming into contact with an entire periphery of each of the stud pins to secure the stud pin;
the securing portion including a plurality of protrusions provided on an inner wall thereof, the protrusions extending in a depth direction of the holes with spacing between the protrusions in a circumferential direction of the holes, the protrusions guiding claws of a pin driver in the depth direction of the holes, the pin driver driving the stud pins into the holes; and
the protrusions deforming to match an outer peripheral surface of the stud pin inserted into each of the holes, such that entire surfaces of the protrusions come into contact with the outer peripheral surface of the stud pin.

3. The pneumatic tire according to claim 2, wherein the number of the protrusions is two to four.

4. The pneumatic tire according to claim 2, wherein when D represents a diameter of a cylinder circumscribing the securing portion, and H represents a protruding height of the protrusion from a protruding base to a protruding tip, a relationship of 0.10≦H/D≦0.30 is satisfied.

5. The pneumatic tire according to claim 2, wherein when D represents a diameter of a cylinder circumscribing the securing portion, and W represents a distance between protruding bases of the protrusion in a circumferential direction of the holes, a relationship of 0.15≦W/D≦0.45 is satisfied.

6. The pneumatic tire according to claim 2, wherein when L represents a length of the securing portion in the depth direction of the holes, and L1 represents a length of the protrusion in the depth direction of the holes, a relationship of 0.125≦L1/L≦1.00 is satisfied.

7. A pneumatic tire comprising:
a tire tread section provided with a plurality of stud pin inserting holes in a tread surface of the pneumatic tire; and
a plurality of stud pins inserted into the holes;
the stud pins each including a recessed portion provided on an outer periphery thereof, the recessed portion extending in a depth direction of the holes;
the holes each including a securing portion provided on an inner wall thereof, the securing portion coming into contact with an entire periphery of each of the stud pins to secure the stud pin;
the securing portion including a protrusion extending in the depth direction of the holes and guiding claws of a pin driver in the depth direction of the holes, the pin driver driving the stud pins into the holes, the protrusion engaging with the recessed portion; and
the protrusion deforming to match an outer peripheral surface of the stud pin inserted into each of the holes, such that an entire surface of the protrusion comes into contact with the outer peripheral surface of the stud pin.

8. A pneumatic tire comprising:
a tire tread section provided with a plurality of stud pin inserting holes in a tread surface of the pneumatic tire; and
a plurality of stud pins inserted into the holes;
the stud pins each including a polygonally prismatic body portion;
the holes each including a securing portion provided on an inner wall thereof, the securing portion coming into contact with an entire periphery of the body portion to secure each of the stud pins;
the securing portion including a plurality of protrusions extending in the depth direction of the holes with spacing between the protrusions in a circumferential direction of the holes, the protrusions guiding claws of a pin driver in the depth direction of the holes, the pin driver driving the stud pins into the holes; and
the protrusions deforming to match an outer peripheral surface of the body portion, such that entire surfaces of the protrusions come into contact with the outer peripheral surface of the body portion.

9. The pneumatic tire according to claim 1, wherein when D represents a diameter of a cylinder circumscribing the securing portion, and H represents a protruding height of the protrusion from a protruding base to a protruding tip, a relationship of 0.10≦H/D≦0.30 is satisfied.

10. The pneumatic tire according to claim 1, wherein when D represents a diameter of a cylinder circumscribing the securing portion, and W represents a distance between protruding bases of the protrusion in a circumferential direction of the holes, a relationship of 0.15≦W/D≦0.45 is satisfied.

11. The pneumatic tire according to claim 1, wherein when L represents a length of the securing portion in the depth direction of the holes, and L1 represents a length of the protrusion in the depth direction of the holes, a relationship of 0.125≦L1/L≦1.00 is satisfied.

12. The pneumatic tire according to claim 3, wherein when D represents a diameter of a cylinder circumscribing the securing portion, and H represents a protruding height of the protrusion from a protruding base to a protruding tip, a relationship of 0.10≦H/D≦0.30 is satisfied.

13. The pneumatic tire according to claim 4, wherein when D represents a diameter of a cylinder circumscribing the securing portion, and W represents a distance between protruding bases of the protrusion in a circumferential direction of the holes, a relationship of 0.15≦W/D≦0.45 is satisfied.

14. The pneumatic tire according to claim 5, wherein when L represents a length of the securing portion in the depth direction of the holes, and L1 represents a length of the protrusion in the depth direction of the holes, a relationship of 0.125≦L1/L≦1.00 is satisfied.
